(19) United States
(12) Patent Application Publication
(10) Pub. No.: US 2026/0062903 A1
(43) Pub. Date: Mar. 5, 2026

(54) WATER MIXER TAP

(71) Applicant: BLACKSHEEP TRIBES HOLDING SRL, Corbais (BE)

(72) Inventor: GEOFFROY FAUVEAUX, Corbais (BE)

(21) Appl. No.: 18/998,385

(22) PCT Filed: Jul. 26, 2023
(86) PCT No.: PCT/EP2023/070768

§ 371 Date: Jan. 24, 2025

(30) Foreign Application Priority Data
Jul. 26, 2022 (EP) 22186963.9

(51) Int. Cl. E03C 1/044; F16K 11/00; F16K 11/074

(52) U.S. Cl. CPC E03C 1/044; F16K 11/074; F16K 19/006; E03C 2201/40

(57) ABSTRACT

The invention relates to a four-way mixer tap comprising a first water inlet (11), for example for receiving recirculated water, a second water inlet (12), for example for receiving cold water, a third water inlet (13), for example for receiving hot water, and a single water outlet (20). The mixer tap comprises passage means for placing the single water outlet (20) in fluid communication either with only the first water inlet (11), or with only the first water inlet (11) and the second water inlet (12), or with only the first water inlet (11) and the third water inlet (13). The invention also relates to a water supply assembly comprising such a mixer tap and to a water supply installation comprising such an assembly.

### FIELD OF THE INVENTION The invention relates to the field of hot and cold water mixer taps, such as shower, bath, or kitchen sink mixer taps.

The invention also relates to a water supply assembly having such a water mixer tap and to a water supply installation having such an assembly.

### PRIOR ART

Water mixer taps have been known for some time and enable hot water and cold water to be mixed in various proportions in order to provide a user with water at a desired temperature at the outlet.

Patent application US2020299937 discloses such a mixer tap, for example. This mixer tap comprises two inlets, one for hot water and one for cold water, as well as an outlet supplying a mixture of a quantity of hot water and a quantity of cold water, as chosen by the user. This mixer tap is part of an installation in which waste water is also recycled and added downstream to the clean water leaving the mixer tap for reuse.

Such an installation is also disclosed in patent US2020141838 and functions substantially in the same manner.

However, such installations do not allow the quantity of waste water which is reused to be selected or regulated.

Patent EP2793667 also discloses such an installation although it does not have a mixer tap.

Finally, commercial mixer taps are known which supply a mixture of hot and cold water to a first outlet and which also comprise a third inlet in exclusive communication with a second outlet in order to supply, for example, sparkling water or filtered water to this second outlet. However, such mixer taps are not suitable for recycling waste water or for mixing waste water with fresh, hot and/or cold water.

### SUMMARY OF THE INVENTION

One object of the invention is to address the problems associated with known mixer taps.

The invention is defined by the independent claims. The dependent claims define preferred embodiments of the invention.

According to the invention, a four-way water mixer tap is provided having a first water inlet, a second water inlet, a third water inlet and a single water outlet.

The mixer tap also has passage means for placing the single water outlet in fluid communication:
a. either with only the first water inlet,
b. or with only the first water inlet and the second water inlet,
c. or with only the first water inlet and the third water inlet.

Such a mixer tap can supply, at its single outlet and at the request of a user, either only a quantity of the water supplied to its first inlet, for example only recycled water, or a mixture of a quantity of the water supplied to its first inlet and a quantity of the water supplied to its second inlet, for example a mixture of recycled water and cold water, or a mixture of a quantity of the water supplied to its first inlet and a quantity of the water supplied to its third inlet, for example a mixture of recycled water and hot water.

The mixer tap preferably also has passage means for placing the single water outlet in fluid communication with only the second water inlet and the third water inlet. In addition to the aforementioned mixtures, such a mixer tap can supply, at its single outlet and at the request of a user, a mixture of a quantity of the water supplied to its second inlet and a quantity of the water supplied to its third inlet, for example a mixture of cold and hot non-recycled water.

The mixer tap preferably also has passage means for placing the single water outlet in fluid communication with only the second water inlet, for example cold non-recycled water, or with only the third water inlet, for example hot non-recycled water. This provides more flexibility in the composition of the water supplied to the single outlet of the mixer tap.

The mixer tap also preferably has means for controlling a water flow at the single water outlet, said control means being able to be activated by a user. The mixer tap also preferably has means for regulating the water temperature at the single water outlet as a function of an outlet water temperature setpoint.

The invention also provides a water supply assembly having such a mixer tap and a water supply installation having such an assembly.

### BRIEF DESCRIPTION OF THE FIGURES

These aspects as well as other aspects of the invention will be clarified in the detailed description of particular embodiments of the invention, reference being made to the drawings of the figures, wherein:

FIG. 1 schematically shows a mixer tap according to the invention;

FIG. 2 schematically shows a cross-section of a first exemplary embodiment of passage means of a mixer tap according to the invention;

FIG. 3 schematically shows an axial cross-section of the first exemplary embodiment of passage means of a mixer tap according to the invention;

FIG. 4 schematically shows a second exemplary embodiment of passage means of a mixer tap according to the invention;

FIG. 5 schematically shows a water supply assembly according to the invention;

FIG. 6 schematically shows a preferred water supply assembly according to the invention;

FIG. 7 schematically shows a water supply installation according to the invention;

FIG. 8 schematically shows a preferred water supply installation according to the invention;

FIG. 9 schematically shows a more preferred water supply installation according to the invention.

The drawings of the figures are neither to scale nor proportionate. In general, similar or identical elements are denoted by identical reference numerals in the figures.

### DETAILED DESCRIPTION OF EMBODIMENTS OF THE INVENTION

FIG. 1 schematically shows a mixer tap according to the invention.

It is said to be four-way because it has three water inlets (11, 12, 13) and a single water outlet (20) and it has means for supplying, at its single water outlet, a mixture of the water from combinations of two of the three inlets. More specifically, the mixer tap according to the invention has a first water inlet (11), a second water inlet (12), a third water inlet (13) and a single water outlet (20), and it has passage means for placing the single water outlet (20) in fluid communication:
a. either with only the first water inlet (11),
b. or with only the first water inlet (11) and the second water inlet (12),
c. or with only the first water inlet (11) and the third water inlet (13).

Said passage means can take a number of forms.

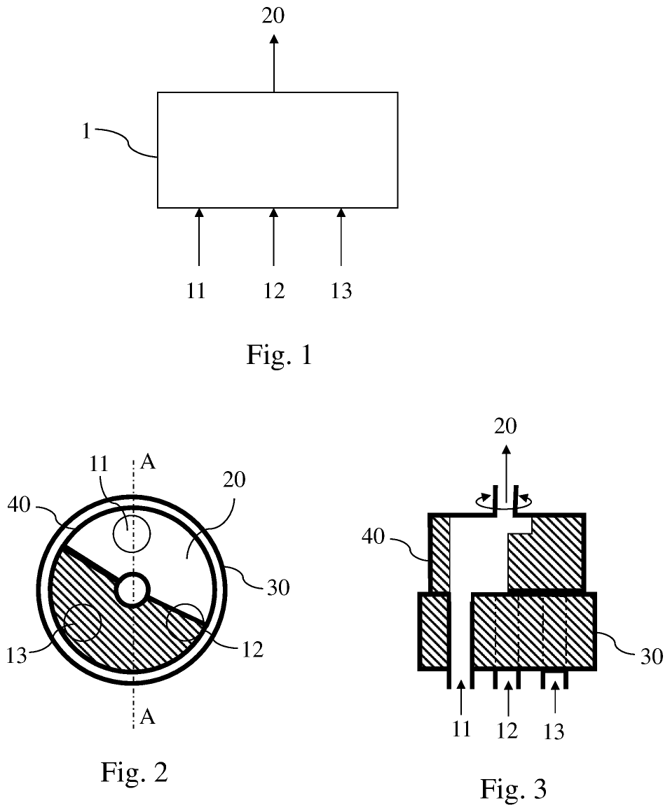

FIG. 2 schematically shows a cross-section of a first exemplary embodiment of the passage means. According to this first exemplary embodiment, the passage means have a first cylinder (30) including three axial channels opening out at a first end of the first cylinder (30) and opening out at the opposite end of the first cylinder (30) to respectively form the first water inlet (11), the second water inlet (12) and the third water inlet (13). The passage means have a second cylinder (40) abutting the first cylinder (30) and including an axial recess having, for example, the shape shown in cross-section in FIG. 2 (unshaded part of the cross-section of the second cylinder (40)). One end of the second cylinder (40) faces the first end of the first cylinder (30) and the opposite end of the second cylinder (40) forms the single water outlet (20).

By positioning the second cylinder (40) at different angles relative to the first cylinder (30), it is thus possible to place said axial recess of the second cylinder (40) either facing the first channel, or facing the second channel, or facing the third channel, or facing a combination of two axial channels of the first cylinder (30).

The angular positioning of the second cylinder with respect to the first cylinder can be achieved, for example, by means of a lever connected to the second cylinder, the first cylinder being fixed, or vice versa.

In the position as shown in FIG. 2, the first cylinder (30) is, for example, positioned in an angular position relative to the second cylinder (40) such that the axial recess faces the first axial channel and partially faces the second axial channel such that the single water outlet (20) will be in fluid communication with the first water inlet (11) and partially with the second water inlet (12).

Turning the second cylinder (40) slightly anticlockwise also positions the axial recess to face only the first axial channel such that the single water outlet (20) will be in fluid communication with only the first water inlet (11).

Continuing to turn the second cylinder (40) anticlockwise also positions the axial recess to face the first axial channel and to face the third axial channel such that the single water outlet (20) will be in fluid communication with the first water inlet (11) and with the third water inlet (13).

Preferably, and as is the case in the exemplary embodiment shown in FIGS. 2 and 3, the passage means can place the single water outlet (20) in fluid communication with only the second water inlet (12) and the third water inlet (13). In the example shown in FIGS. 2 and 3, the second cylinder (40) simply has to be turned anticlockwise until the axial recess faces the second axial channel and the third axial channel.

Preferably, and as is the case in the exemplary embodiment shown in FIGS. 2 and 3, the passage means can place the single water outlet (20) in fluid communication with only the second water inlet (12) or with only the third water inlet (13).

FIG. 3 schematically shows an axial cross-section (along A-A) of the first exemplary embodiment of passage means of a mixer tap according to the invention.

The overlay of the two cylinders is shown when they are positioned at an angle relative to one another as in FIG. 2. The two cylinders can, for example, be made of ceramic to ensure flat, wear-resistant contact between the two cylinders. As in a conventional mixer tap, it is also possible to provide seals between the two cylinders and/or a casing external to the first and/or second cylinder (40).

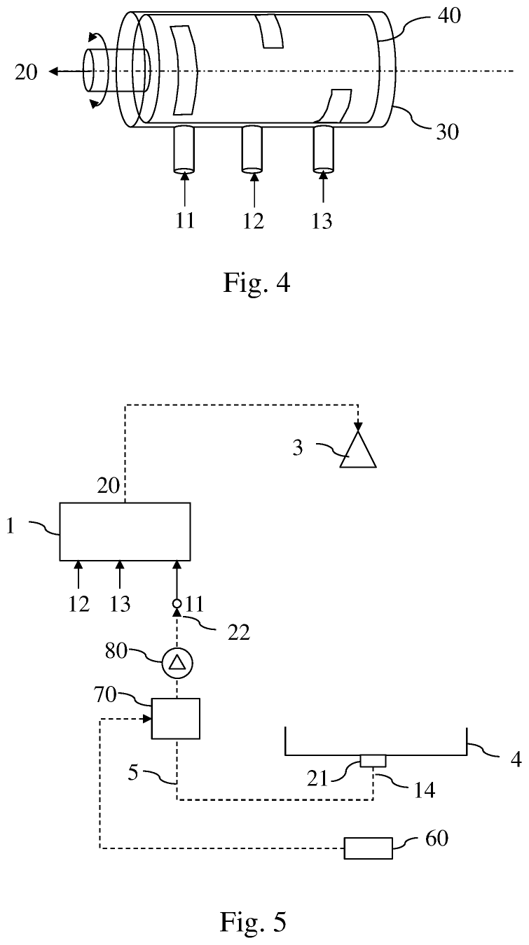

FIG. 4 schematically shows a second exemplary embodiment of passage means of a mixer tap according to the invention. According to this exemplary embodiment, the mixer tap has a first cylinder (30) and a second cylinder (40) embedded in the first cylinder (30). The first cylinder (30) is a fixed cylinder and it has three inlets, respectively the first water inlet (11), the second water inlet (12), and the third water inlet (13). The second cylinder (40) has the single water outlet (20) at one of its ends and has three openings over its circumference respectively occupying three circular arcs that are angularly and axially offset from one another. Each of the three openings is located in a transverse plane which respectively intersects each of the three water inlets. By positioning the second cylinder (40) at different angles relative to the first cylinder (30), it is thus possible to place the openings of the second cylinder (40) either facing the first water inlet (11), or facing the second water inlet (12), or facing the third water inlet (13), or facing a combination of two of the three water inlets of the first cylinder (30).

In the position as shown in FIG. 4, the first cylinder (30) is, for example, positioned in an angular position relative to the second cylinder (40) such that only one of the three openings (the one furthest to the right in FIG. 4) is facing the third inlet of the second cylinder (40) such that the single water outlet (20) will be in fluid communication with only the third water inlet (13). It is understood that turning the second cylinder (40) clockwise or anticlockwise will result in the other combinations as described with reference to FIGS. 2 and 3.

The angular positioning of the second cylinder with respect to the first cylinder can be achieved, for example, by means of a lever connected to the second cylinder, the first cylinder being fixed, or vice versa.

The mixer tap also preferably has means for controlling a water flow at the single water outlet (20), said control means being able to be activated by a user. In the example shown in FIG. 3, said control means can, for example, have a valve mounted at the single outlet of the mixer tap.

In the example shown in FIG. 4, said control means can, for example, have an outer ring fixed to the second cylinder (40) and connected so as to be mobile in axial translation to the first cylinder (30) so as to be able to move the second cylinder (40) axially relative to the first cylinder (30) and thus vary the axial position of the three openings.

FIG. 5 schematically shows an assembly for supplying water to a user according to the invention. This assembly has a mixer tap (1) according to the invention and as described above, for example, as well as a device (3) for supplying water to the user, connected or able to be connected fluidically to the single water outlet (20) of the mixer tap, as shown by a dotted line in FIG. 5. This water supply device (3) can, for example, be a showerhead or a tap spout. The assembly also has an open container (4) for collecting the water after having been provided by the water supply device (3). This open container (4) can, for example, be a shower tub or tray, or a washbasin or bathtub. If used for a shower, the water supply device (3) can, for example, be a showerhead and the open container (4) can, for example, be a shower tub or tray.

The assembly also has a hydraulic circuit (5) having a fourth water inlet (14) connected or able to be connected fluidically to a first water outlet (21) of the open container (4) and having a second water outlet (22) connected or able to be connected fluidically to the first water inlet (11) of the mixer tap, as shown by a dotted line in the figure. The hydraulic circuit (5) has at least one filter (70) and a pump (80) to pump water from the open container (4) to the first water inlet (11) of the mixer tap.

The filter (70) can, for example, be a sand filter or an activated carbon filter. The pump (80) can be any type of pump suitable for pumping water, preferably a pump suitable for pumping hot water.

The pump (80) is preferably mounted downstream of the filter (70), as shown in FIG. 5.

The water supply assembly according to the invention preferably also has a control unit (60) connected or able to be connected to the pump and designed to control and start the pump (80) provided that water is present in the open container (4) and the mixer tap (1) is moved to a position where the single water outlet (20) is at least partially in fluid connection with the first water inlet (11).

The position of the mixing tap can be detected by the control unit (60) by various known means, for example by means of a code wheel mounted on the moving part of the mixing tap (for example on the second cylinder 40 in the example shown in FIG. 3) and connected to the control unit. The presence of water in the open container (4) can be detected by the control unit (60) by various known means, for example by means of a sensor for the water level or presence of water in the open container (4) and connected to the control unit.

The control unit is preferably designed to start the pump when the mixer tap (1) is moved to a position where the single water outlet (20) is at least partially in fluid communication with the first water inlet (11) and a minimum water level is present in the open container (4), and to stop the pump once one of these two conditions is no longer met.

This hydraulic circuit (5) enables the waste water collected in the open container (4) to be recycled and, after being filtered, re-injected into the water supply device (3) via the mixer tap.

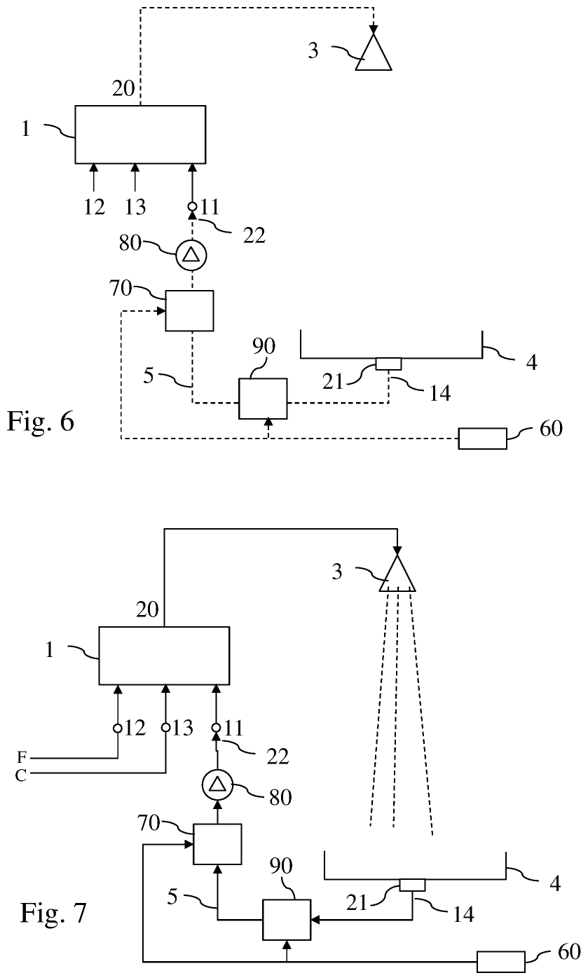

FIG. 6 schematically shows a preferred water supply assembly according to the invention. This assembly is identical to the assembly shown in FIG. 5 except that the hydraulic circuit (5) also includes here a device (90) for heating the water which flows through this hydraulic circuit (5) when the pump (80) is in operation.

The advantage of providing such a heating device is to be able to maximise the quantity of recycled water whilst maintaining comfort for the user in terms of heat, and thus to minimise the consumption of hot non-recycled water.

The heating device (90) can, for example, have an electric heating element, as used in a conventional instantaneous water heater for example.

According to one exemplary embodiment, the heating device (90) has a fixed heat capacity, i.e. an all-or-nothing “ON/OFF” device. It can, for example, be an electric heating element which is either powered or not powered, depending on whether or not there is a need to heat the water which flows in the hydraulic circuit (5). In this case, the control unit (60) is designed to switch the heating device (90) on or off as a function of a difference between a temperature measured by the control unit and a setpoint temperature supplied to the control unit. The control unit (60) is, for example, designed to switch the heating device (90) on when the difference between the measured temperature and the setpoint temperature exceeds a predetermined threshold and provided that the pump is in operation, and to switch the heating device (90) off when the difference between the measured temperature and the setpoint temperature falls below a predetermined threshold or the pump is stopped.

The temperature measured by the control unit is preferably a temperature measured downstream of the single outlet (20) of the mixer tap (1), for example by means of a temperature sensor to be placed at such a location and connected to the control unit. The setpoint temperature can, for example, be supplied to the control unit by means of a potentiometer or keys connected to the control unit and which can be operated by a user.

According to another exemplary embodiment, the heating device (90) has a variable heat capacity and the control unit (60) is designed to modify the heating power of the heating device (90) as a function of the setpoint temperature selected by the user. It can, for example, be an electric heating element, the power supply of which is modulated by the control unit (60) as a function of the difference between the measured temperature and the setpoint temperature as described above. As this type of heating is known elsewhere, it will not be described in detail here.

FIG. 7 schematically shows a water supply installation according to the invention. As shown in the example in FIG. 7, the installation has a water supply assembly according to the invention and as described above, for example, as well as a cold water supply (F) and a hot water supply (C). The open container (4) is arranged to collect the water after having been provided by the water supply device (3). In the case of a shower installation, for example, the open container (4) can be a shower tub placed vertically to a showerhead (3).

According to this installation, the second water inlet (12) of the mixer tap is connected to the cold water supply (F) and the third water inlet (13) of the mixer tap is connected to the hot water supply (C). This therefore makes it possible to supply the water supply device (3) either with hot water from the hot water supply (C), or cold water from the cold water supply (F), or recycled water from the open container (4), or a mixture from a plurality of these sources. As explained above, such a water supply installation according to the invention makes it possible to maximise the quantity of recycled water whilst maintaining comfort for the user in terms of heat, and thus to minimise the consumption of hot non-recycled water, i.e. from the hot water supply (C).

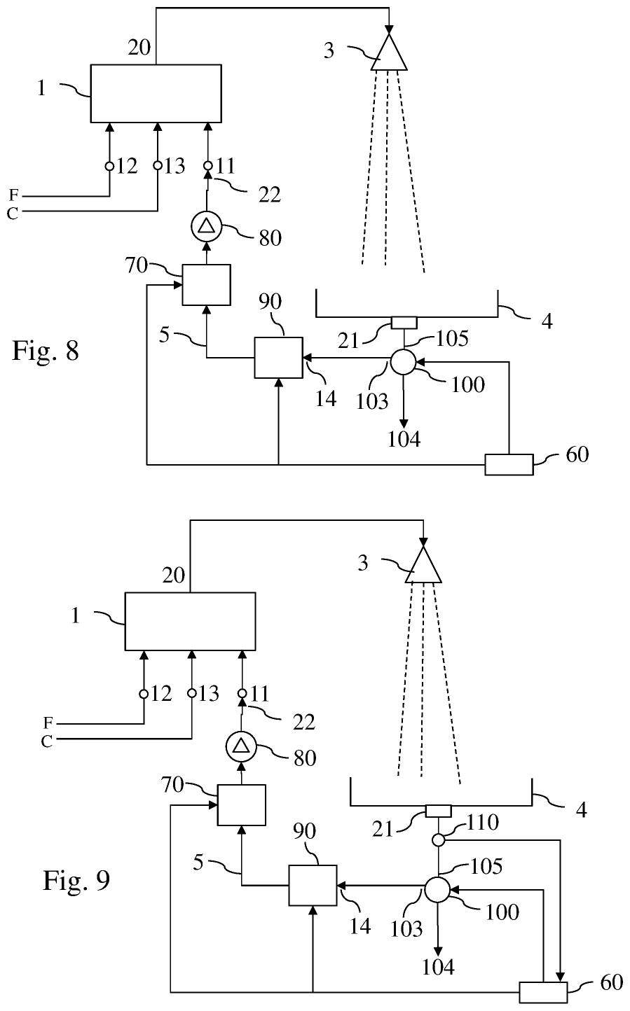

FIG. 8 schematically shows a preferred water supply installation according to the invention. This installation is identical to the installation shown in FIG. 7, except that the installation also has a drain inlet and a controllable three-way valve (100), a fifth water inlet (105) of which is fluidically connected to the first water outlet (21) of the open container (4), a third water outlet (103) of which is fluidically connected to the fourth water inlet (14) of the hydraulic circuit (5), and a fourth water outlet (104) of which is fluidically connected to the drain inlet.

Said controllable valve (100) is, for example, a solenoid valve. The control unit (60) is in this case designed to act on the valve (100) in order to either place the first water outlet (21) of the open container (4) in fluid connection with the fourth water inlet (14) of the hydraulic circuit (5) (“water recycling mode”) or place the first water outlet (21) of the open container (4) in fluid connection with the drain inlet (“drain”mode).

The three-way valve thus allows all or some of the water from the open container (4) to be discharged into a drain. This may be necessary, for example, if the water from the open container (4) is too dirty, or if the water from the open container (4) is added by the mixer tap (1) to the water supplied to the second and/or to the third water inlet of the mixer tap (1), so that the open container (4) does not overflow.

The control unit (60) is thus designed to act on the two positions of the valve (100) depending on need or circumstances. In order to prevent the open container (4) from overflowing, the installation can also have a water level sensor in the open container (4) and the control unit (60) can in this case be designed to place the first water outlet (21) of the open container (4) in fluid connection with the drain inlet (“drain” mode) as soon as and for as long as the water level in the open container (4) exceeds a predefined level, and to place the first water outlet (21) of the open container (4) in fluid connection with the fourth water inlet (14) of the hydraulic circuit (5) (“water recycling mode”) as soon as and for as long as the water level in the open container (4) is lower than a predefined level.

FIG. 9 schematically shows a more preferred water supply installation according to the invention. This installation is identical to the installation shown in FIG. 8, except that the installation also has a water quality sensor (110) arranged between the first water outlet (21) of the open container (4) and the three-way valve (100). The control unit (60) is in this case also designed to act on the three-way valve and on the pump (80) according to a water quality measurement supplied to it by the water quality sensor (110). In particular, the control unit (60) is in this case designed to act on the valve (100) to place the first water outlet (21) of the open container (4) in fluid connection with the fourth water inlet (14) of the hydraulic circuit (5) as long as the quality of the water leaving the open container (4) and as measured is adequate, for example as long as the quality of the water leaving the open container (4) meets a criterion or a given threshold, and to place the first water outlet (21) of the open container (4) in fluid connection with the drain inlet and to switch the pump (80) off as soon as and for as long as the quality of the water as measured is inadequate.

In the configuration shown in FIG. 9, the control unit is therefore designed to start the pump (80) and thus recycle the water, on the triple condition that the mixer tap (1) is moved to a position where the single water outlet (20) is at least partially in fluid communication with the first water inlet (11), that water is present in the open container (4) and that the quality of the water leaving the open container and as measured is adequate.

The water quality sensor (110) is preferably a water turbidity sensor and the water quality measurement is a water turbidity measurement.

The present invention has been described in connection with specific embodiments, which have a purely illustrative value and should not be considered as restrictive. Generally speaking, it is obvious to a person skilled in the art that the present invention is not limited to the examples illustrated and/or described above. The presence of reference numerals in the drawings should not be considered as restrictive, including when these numerals are indicated in the claims.

The use of the verbs “comprise”, “include”, “have” or any other variation, as well as their conjugations, cannot in any way exclude the presence of elements other than those mentioned.

The use of the indefinite article “a”, “an”, or of the definite article “the”, to introduce an element does not exclude the presence of a plurality of these sensors.

The invention can also be described as follows: a four-way mixer tap having a first water inlet (11), for example for receiving recycled water, and a second water inlet (12), for example for receiving cold water, a third water inlet (13), for example for receiving hot water, and a single water outlet (20). The mixer tap has passage means for placing the single water outlet (20) in fluid communication either with only the first water inlet (11), either with only the first water inlet (11) and the second water inlet (12), or with only the first water inlet (11) and the third water inlet (13). The invention also relates to a water supply assembly having such a mixer tap and to a water supply installation having such an assembly.

1. Four-way water mixer tap comprising a first water inlet a second water inlet, a third water inlet and a single water outlet, wherein the mixer tap has passage means for placing the single water outlet in fluid communication:
a. either with only the first water inlet,
b. or with only the first water inlet and the second water inlet,
c. or with only the first water inlet and the third water inlet.

2. Water mixer tap according to claim 1, wherein the mixer tap further comprises passage means for placing the single water outlet in fluid communication with only the second water inlet and the third water inlet.

3. Water mixer tap according to claim 1, wherein the mixer tap further comprises passage means for placing the single water outlet in fluid communication with only the second water inlet or with only the third water inlet.

4. Water mixer tap according to claim 1, wherein the mixer tap further comprises means for controlling a water flow at the single water outlet, said control means being able to be activated by a user.

5. Assembly for supplying water to a user, the assembly comprising:
a water mixer tap according to claim 1,
a device for providing water to the user, connected or able to be connected fluidically to the single water outlet of the mixer tap,
an open container for collecting the water after having been provided by the water supply device,
a hydraulic circuit having a fourth water inlet connected or able to be connected fluidically to a first outlet of the open container and having a second water outlet connected or able to be connected fluidically to the first water inlet of the mixer tap, said hydraulic circuit having at least one filter and a pump for pumping water from the first outlet of the open container to the first water inlet of the mixer tap,
a control unit connected or able to be connected to the pump and configured to control and start the pump provided that water is present in the open container and provided the mixer tap is moved to a position where the single water outlet is at least partially in fluid connection with the first water inlet.

6. Water supply assembly according to claim 5, wherein the hydraulic circuit includes a device for heating the water flowing through the hydraulic circuit and wherein the control unit is designed to control the heating device as a function of a setpoint temperature.

7. Water supply assembly according to claim 6, wherein the heating device has a fixed heat capacity.

8. Water supply assembly according to claim 6, wherein the heating device has a variable heat capacity.

9. Installation for supplying water to a user having a water supply assembly according to claim 5 as well as a cold water supply and a hot water supply, wherein the open container is arranged to collect the water after having been supplied by the water supply device, wherein the second water inlet of the water mixer tap is connected to the cold water supply, and wherein the third water inlet of the water mixer tap is connected to the hot water supply.

10. Water supply installation according to claim 9, further including a drain inlet and a controllable three-way valve, a fifth water inlet of which is fluidically connected to the first water outlet of the open container, a third water outlet of which is fluidically connected to the fourth water inlet of the hydraulic circuit, and a fourth water outlet of which is fluidically connected to the drain inlet.

11. Water supply installation according to claim 10, further including a control unit configured to act on the controllable three-way valve in order to either place the first water outlet of the open container in fluid connection with the fourth water inlet of the hydraulic circuit or to place the first water outlet of the open container in fluid connection with the drain inlet.

12. Water supply installation according to claim 11, further including a water quality sensor arranged between the first water outlet of the open container and the three-way valve, wherein the control unit is designed to act on the three-way valve according to a water quality measurement provided by the water quality sensor.

13. Water supply installation according to claim 12, wherein the water quality sensor is a water turbidity sensor and wherein the water quality measurement is a water turbidity measurement.
